(19) United States
(12) Patent Application Publication
(10) Pub. No.: US 2007/0139189 A1
(43) Pub. Date: Jun. 21, 2007

(54) Multi-platform monitoring system and method

(76) Inventor: Kevin Stewart Helmig, Candia, NH (US)

Correspondence Address: Brian J. Colandreo;Grossman, Tucker, Perreault & Pileger, PLLC, 55 South Commercial Street, Manchester, NH, 03101, US

(21) Appl. No.: 11/294,094

(22) Filed: Dec. 5, 2005

(51) Int. Cl. G08B 1/08

(52) U.S. Cl. 340/539.13; 455/456.1; 340/539.18; 340/825.49

(57) ABSTRACT

A method, computer program product, and system for receiving a data signal from a transmitting device. The data signal is processed to determine if the data signal is a device data signal or a personal data signal. If the data signal is a device data signal, the device data signal is routed to a device monitoring system. If the data signal is a personal data signal, the personal data signal is routed to a personal monitoring system.

### FIELD OF THE DISCLOSURE

This disclosure relates to monitoring systems and methods and, more particularly, to multi-platform monitoring systems and methods.

### BACKGROUND

Asset tracking systems (e.g., asset tracking devices, vehicle assistant devices, and fleet management devices) may be used to monitor the location/condition of various assets (e.g., vehicles and goods, for example). Typically, asset tracking systems receive GPS satellite signals (to be discussed below) and convert the signals received into a location signal that is transmitted to a remote device monitoring system.

Personal monitoring systems may be worn by individuals and may be used to monitor the location/condition of an individual. Typically, personal monitoring systems receive GPS satellite signals and convert the signals received into a location signal that is transmitted to a remote personal monitoring system.

Unfortunately, when a customer wishes to monitor the location/condition of both assets and individuals, multiple monitoring systems must be utilized (i.e., one to monitor the location/condition of individuals and another to monitor the location / condition of assets.

### SUMMARY OF THE INVENTION

According to an aspect of this disclosure, a method includes receiving a data signal from a transmitting device. The data signal is processed to determine if the data signal is a device data signal or a personal data signal. If the data signal is a device data signal, the device data signal is routed to a device monitoring system. If the data signal is a personal data signal, the personal data signal is routed to a personal monitoring system.

One or more of the following features may also be included. The data signal may be a device data signal; and the transmitting device may be chosen from the group consisting of a fleet management device, a vehicle assistant device, and an asset tracking device. The data signal may be a personal data signal; and the transmitting device may be a personal monitoring device.

The transmitting device may include a GPS receiver for receiving a GPS signal from at least one of a plurality of GPS satellites. The transmitting device may be configured to process the GPS signal to generate a location signal indicative of a location of the transmitting device; and the location signal may be included in the data signal.

The location signal included within the data signal may be processed to determine the location of the transmitting device. The transmitting device may include a cellular transmitter for transmitting the data signal to a cellular network. The data signal may include a device identifier for identifying the transmitting device. The data signal may be processed to extract the device identifier. A device identity may be associated with the extracted device identifier.

The data signal may include a voice-based signal component. The data signal may be routed to a dispatcher.

According to another aspect of this disclosure, a computer program product residing on a computer readable medium has a plurality of instructions stored thereon. When executed by the processor, the instructions cause that processor to perform operations comprising receiving a data signal from a transmitting device. The data signal is processed to determine if the data signal is a device data signal or a personal data signal. If the data signal is a device data signal, the device data signal is routed to a device monitoring system. If the data signal is a personal data signal, the personal data signal is routed to a personal monitoring system.

One or more of the following features may also be included. The data signal may be a device data signal; and the transmitting device may be chosen from the group consisting of a fleet management device, a vehicle assistant device, and an asset tracking device. The data signal may be a personal data signal; and the transmitting device may be a personal monitoring device.

The transmitting device may include a GPS receiver for receiving a GPS signal from at least one of a plurality of GPS satellites. The transmitting device may be configured to process the GPS signal to generate a location signal indicative of a location of the transmitting device; and the location signal may be included in the data signal.

The location signal included within the data signal may be processed to determine the location of the transmitting device. The transmitting device may include a cellular transmitter for transmitting the data signal to a cellular network. The data signal may include a device identifier for identifying the transmitting device. The data signal may be processed to extract the device identifier. A device identity may be associated with the extracted device identifier.

The data signal may include a voice-based signal component. The data signal may be routed to a dispatcher.

According to another aspect of this disclosure, a system is configured for receiving a data signal from a transmitting device. The data signal is processed to determine if the data signal is a device data signal or a personal data signal. If the data signal is a device data signal, the device data signal is routed to a device monitoring system. If the data signal is a personal data signal, the personal data signal is routed to a personal monitoring system.

One or more of the following features may also be included. The data signal may be a device data signal; and the transmitting device may be chosen from the group consisting of a fleet management device, a vehicle assistant device, and an asset tracking device. The data signal may be a personal data signal; and the transmitting device may be a personal monitoring device.

The transmitting device may include a GPS receiver for receiving a GPS signal from at least one of a plurality of GPS satellites. The transmitting device may be configured to process the GPS signal to generate a location signal indicative of a location of the transmitting device; and the location signal may be included in the data signal.

The location signal included within the data signal may be processed to determine the location of the transmitting device. The transmitting device may include a cellular transmitter for transmitting the data signal to a cellular network. The data signal may include a device identifier for identifying the transmitting device. The data signal may be processed to extract the device identifier. A device identity may be associated with the extracted device identifier.

The data signal may include a voice-based signal component. The data signal may be routed to a dispatcher.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a block diagram of a data network including a monitoring system and a plurality of transmitting devices;

FIG. 2 is a more-detailed view of the transmitting devices of FIG. 1; and

FIG. 3 is a diagrammatic view of the monitoring system of FIG. 1.

### DETAILED DESCRIPTION OF THE PREFERRED EMBODIMENTS

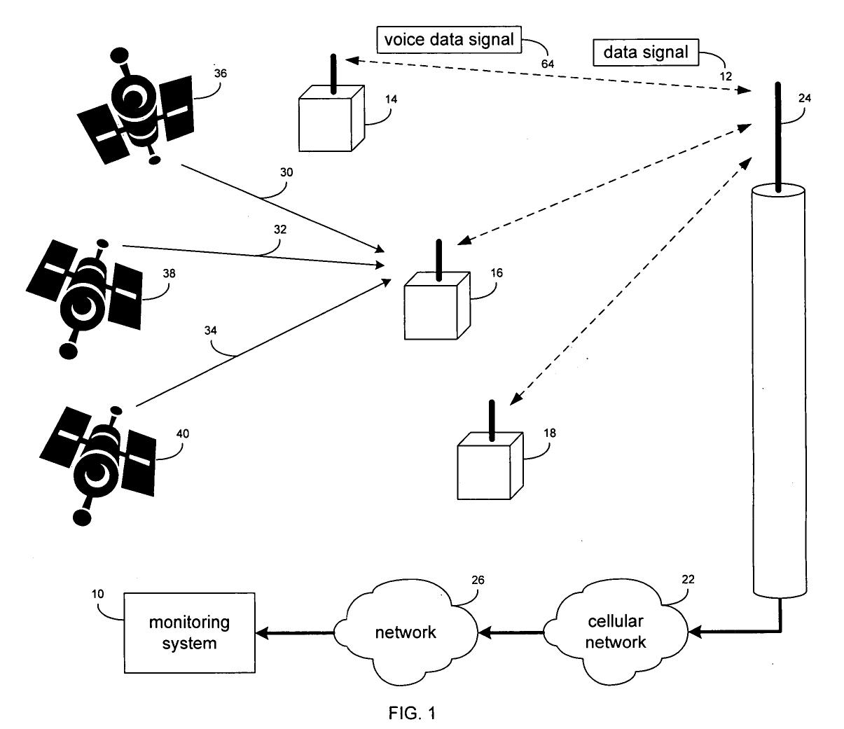

Referring to FIGS. 1 & 2, there is shown a monitoring system 10 configured to receive data signals (e.g., data signal 12) from and/or provide data signals (e.g., data signal 12) to one or more transmitting devices 14, 16, 18. Transmitting devices 14, 16, 18 may include a transceiver for communicating with a communications network. For example, cellular transceiver 20 may be included within one or more of transmitting devices 14, 16, 18 and allow transmitting devices 14, 16, 18 to be wirelessly coupled with cellular network 22 via e.g. cellular tower 24. Examples of cellular network 22 include a GSM (i.e., Global System for Mobile Communications) network. GSM networks typically operate at various different radio frequencies (e.g., 900 MHz and/or 1800 MHz outside of the United States and Canada; and 850 MHz and/or 1900 MHz within the United States and Canada). Cellular network 22 may be coupled (e.g., wired or wirelessly) to one or more additional networks 26 using a gateway (e.g., a gateway GPRS support node in a GSM network; not shown). Examples of network 26 include local area networks, wide area networks, an intranet, the internet, or some other form of network). Network 26 may be coupled (e.g., wired or wirelessly) to monitoring system 10.

Data signal 12 may be transmitted to system 10 periodically (i.e., once per day, hour, or minute, for example), or in response to a request made to the transmitting device by a dispatcher (to be discussed below in greater detail).

Examples of transmitting devices 14, 16, 18 may include an asset tracking device, a fleet management device, a vehicle assistant device and/or a personal monitoring device, each of which is discussed below in greater detail.

Transmitting devices 14, 16, 18 may include a GPS (i.e., global positioning system) receiver 28 for receiving GPS signals 30, 32, 34 from one or more GPS satellites 36, 38, 40 (respectively). GPS is a satellite navigation system used for determining the location of a GPS receiver and/or providing a time reference almost anywhere on the Earth or in the Earth's orbit. GPS typically uses an intermediate circular orbit (ICO) satellite constellation of at least twenty-four satellites to provide GPS signals (e.g., signals 30, 32, 34) to GPS receivers (e.g., GPS receiver 28).

GPS was designed by and is controlled by the United States Department of Defense and is divided into three segments: space, control and user. The space segment comprises the GPS satellite constellation (e.g., satellites 36, 38, 40). The control segment comprises one or more ground stations (not shown) that are responsible for monitoring the flight paths of the GPS satellites, synchronizing the satellites' onboard atomic clocks, and uploading data for transmission by the satellites. The user segment consists of GPS receivers (e.g., GPS receiver 28) used for both military and civilian applications. GPS receiver 28 decodes time signal transmissions from multiple satellites and calculates the position of the GPS receiver by trilateration.

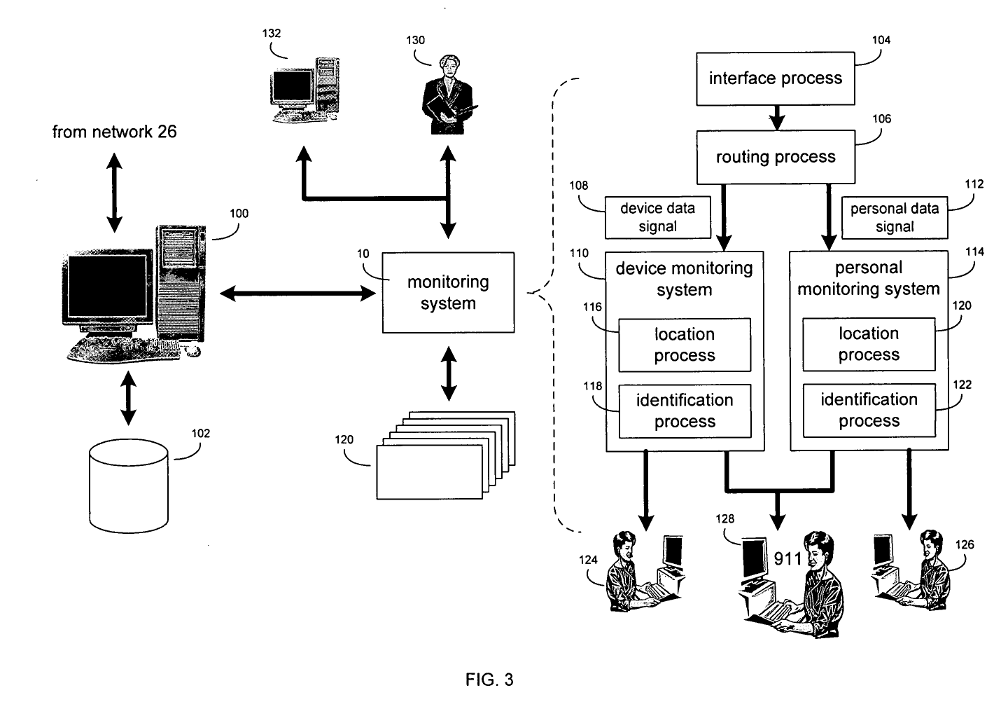

Referring also to FIG. 3, monitoring system 10 typically resides on and is executed by a computing device 100 (e.g., a computer and/or a specialized electronic device, for example) that is coupled (e.g., wired or wirelessly) to network 26. The instruction sets and subroutines of monitoring system 10 may be stored on a storage device 102 connected to computing device 100. Storage device 102 may be, for example, a hard disk drive, a tape drive, an optical drive, a RAID array, a random access memory (RAM), or a read-only memory (ROM). Alternatively or additionally, monitoring system 10 may be embodied within an integrated circuit incorporated into an electronic device (not shown).

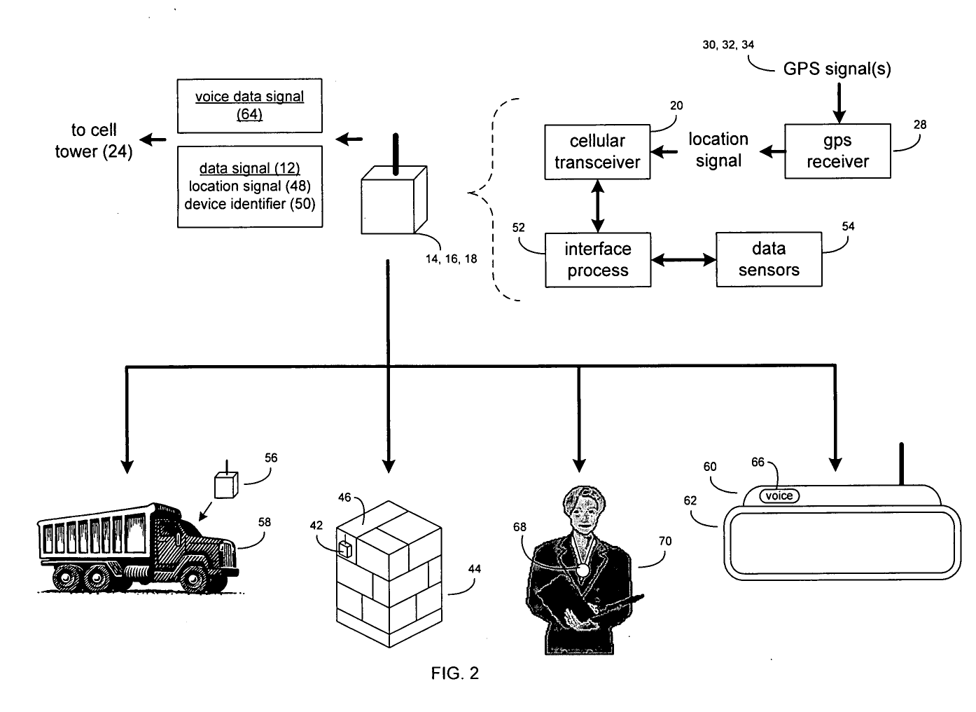

As discussed above, examples of transmitting devices 14, 16, 18 may include an asset tracking device, a fleet management device, a vehicle assistant device and/or a personal monitoring device. Referring again to FIG. 2, an asset tracking device 42 is a transmitting device that may be attached to an asset being tracked (e.g., pallet 44) to e.g., monitor the location of the tracked asset. Additionally/alternatively, an individual parcel/package (e.g., package 46) included within pallet 44 may be tracked.

Asset tracking device 42 may receive GPS signals 30, 32, 34 from GPS satellites 36, 38, 40 and process these signals to generate a location signal 48 indicative of the location of asset tracking device 42. Location signal 48 may then be incorporated into data signal 12 and data signal 12 may be provided (via cellular network 22 and data network 26) to monitoring system 10. Examples of location signal 48 may include: a street address, latitudinal/longitudinal coordinates, or the individual GPS satellite signals. If the individual satellite signals (e.g., signals 30, 32, 34) are provided to monitoring system 10, monitoring system 10 may subsequently process these signals to generate e.g., a street address and/or latitudinal/longitudinal coordinates. Location signal 48 may be incorporated into data signal 12 periodically (i.e., once per day, hour, or minute, for example), or in response to a request made to the transmitting device by a dispatcher (to be discussed below in greater detail).

Data signal 12 may incorporate a device identifier 50 into data signal 12 for uniquely identifying the transmitting device. For example, if (as described above) the transmitting devices communicate on a cellular network (e.g., cellular network 22), device identifier 50 may be a cellular telephone number assigned to the device. Alternatively, if the transmitting device communicates via a standard wireless data network, the device identifier may be an IP address. Alternatively still, device identifier 50 may be a device serial number or a MAC address.

Asset tracking device 42 may include additional circuitry (e.g., interface system 52 and/or data sensors 54) that allows asset tracking device 42 to include additional information within data signal 12. For example, asset tracking device 42 may include an ambient temperature sensor (not shown) for monitoring the ambient temperature and including an ambient temperature signal (not shown) within data signal 12. Other sensor types may include e.g. humidity sensors, altitude sensors, acceleration sensors, vibration sensors and barometric pressure sensors, for example.

Fleet management device 56 may be affixed to fleet vehicle 58 so that e.g., the location of the fleet vehicle may be monitored. As with asset tracking device 42, fleet management device 56 may receive GPS signals 30, 32, 34 from GPS satellites 36, 38, 40 and process these signals to generate location signal 48, which is indicative of the location of fleet management device 56. As discussed above, location signal 48 may be incorporated into data signal 12 and data signal 12 may be provided (via cellular network 22 and data network 26) to monitoring system 10. Fleet management device 56 may also incorporate device identifier 50 within data signal 12 for uniquely identifying the transmitting device.

Fleet management device 56 may include additional circuitry (e.g., interface system 52 and/or data sensors 54) that allows fleet management device 56 to include additional information within data signal 12. For example, fleet management device 56 may include e.g., ambient temperature sensors, humidity sensors, altitude sensors, acceleration sensors, vibration sensors and barometric pressure sensors, for example. Further, fleet management device 56 may be interfacable with e.g., one or more computing devices within fleet vehicle 58. For example, if fleet vehicle 58 includes a computing device (not shown) for monitoring the conditions of the engine within fleet vehicle 58, fleet management device 56 may be configured to interface with the computing device so that the e.g., operating temperature, oil pressure, mileage and/or trouble codes may be monitored.

Vehicle assistant device 60 may be affixed to e.g., the rearview mirror 62 of a vehicle within the proximity of the driver or passenger of the vehicle. As with asset tracking device 42 and fleet management device 56, vehicle assistant device 60 may receive GPS signals 30, 32, 34 from GPS satellites 36, 38, 40 and process these signals to generate location signal 48, which is indicative of the location of vehicle assistant device 60. As discussed above, location signal 48 may be incorporated into data signal 12 and data signal 12 may be provided (via cellular network 22 and data network 26) to monitoring system 10. Vehicle assistant device 60 may also incorporate device identifier 50 within data signal 12 for uniquely identifying the transmitting device.

Vehicle assistant device 60 may be interfacable with e.g., one or more computing devices within the vehicle in which vehicle assistant device 60 is installed. For example, if the vehicle includes a computing device (not shown) for monitoring the conditions of the vehicle, vehicle assistant device 60 may be configured to interface with the computing device so that the e.g., operating condition of the vehicle and the occurrence of specific events (e.g., the deployment of an airbag) can be monitored.

Vehicle assistant device 60 may also be configured to allow for voice-based communication (via voice data signal 64) with monitoring system 10. For example, when a user of vehicle assistant device 60 depresses e.g., button 66 incorporated into vehicle assistant device 60, the user of the device may be connected to a live dispatcher. Depending on the type of voice-based communication (e.g., emergency or concierge, for example), the dispatcher may be proximate monitoring system 10 or may be e.g., a 911 emergency dispatcher external to monitoring system 10.

Personal monitoring device 68 may be worn by a user 70 (e.g., around their neck) or may be placed into e.g., a pocket or a purse. As with asset tracking device 42, fleet management device 56, and vehicle assistant device 60, personal monitoring device 68 may receive GPS signals 30, 32, 34 from GPS satellites 36, 38, 40 and process these signals to generate location signal 48, which is indicative of the location of personal monitoring device 68 (and, therefore, user 70). As discussed above, location signal 48 may be incorporated into data signal 12 and data signal 12 may be provided (via cellular network 22 and data network 26) to monitoring system 10. Personal monitoring device 68 may also incorporate device identifier 50 within data signal 12 for uniquely identifying the transmitting device.

Personal monitoring device 68 may also be configured to allow for voice-based communication (via voice data signal 64) with monitoring system 10. For example, when user 70 depresses e.g., a button (not shown) incorporated into personal monitoring system 68, user 70 may be connected to a live dispatcher. As discussed above, depending on the type of voice-based communication (e.g., emergency or concierge, for example), the dispatcher may be proximate monitoring system 10 or may be e.g., a 911 emergency dispatcher external to monitoring system 10.

Referring again to FIG. 3 and as discussed above, transmitting devices 14, 16, 18 may transmit data signals (e.g., signals 12, 64) to and receive data signals (e.g., signals 12, 64) from monitoring system 10. Interface process 104 may receive data signals 12, 64 (via e.g., cellular network 22 and data network 26) from e.g., transmitting devices 14, 16, 18.

Monitoring system 10 may include a routing process 106 for processing the inbound data signal (e.g., data signals 12, 64) to determine whether the inbound data signal is a device data signal or a personal data signal. A device data signal may be defined as a data signal originating from a transmitting device that monitors/interfaces with another device. For example, asset tracking device 42 (i.e., which monitors the location / environment of pallet 44), fleet management device 56 (i.e., which monitors the location / condition of fleet vehicle 58), and vehicle assistant device 60 (i.e., which monitors the location/condition of the vehicle in which vehicle assistant device 60 is installed) may generate a device data signal.

A personal data signal may be defined as a data signal originating from a transmitting device that interfaces with a person. For example, personal monitoring device 68 (i.e., which monitors the location of user 70) may generate a personal data signal.

Accordingly, routing process 106 may route device data signals (e.g., device data signal 108) to device monitoring system 110, and may route personal data signals (e.g., personal data signal 112) to personal monitoring system 114.

As discussed above, data signal 12 may include location signal 48. Additionally/alternatively, voice data signal 64 may include location signal 48). Device monitoring system 110 may include a location process 116 for processing e.g., device data signal 108 to extract location signal 48 included within device data signal 108 to determine the location of the transmitting device. Examples of location signal 48 may include: a street address, latitudinal/longitudinal coordinates, or the individual GPS satellite signals. Accordingly, depending on the type of location signal 48 received, the manner in which location signal 48 is processed may vary. For example, if the location signal received is a street address, location process 116 may merely extract location signal 48 from device data signal 108. Alternatively, if location signal 48 is latitudinal/longitudinal coordinates, upon extracting location signal 48 from device data signal 108, location process 116 may correlate the received latitudinal/longitudinal coordinates with a street address/position on a map. Further, if location signal 48 is the individual GPS satellite signals, the individual signals may be processed by location process 116 to generate latitudinal / longitudinal coordinates, which may then be correlated to a street address/position on a map.

As discussed above, data signal 12 may include device identifier 50. Additionally/alternatively, voice data signal 64 may include device identifier 50. Device monitoring system 110 may include an identification process 118 for processing inbound data signals (e.g., device data signals 108) to extract device identifier 50 and identify the device that transmitted the data signal. As discussed above, examples of device identifier 50 may include a cellular telephone number assigned to the transmitting device, an IP address, a device serial number and/or a MAC address.

Monitoring system 10 may maintain a database 120 that correlates each assigned device identifier with a description for the transmitting device associated with the device identifier. Examples of database 120 may include a Microsoft Access database^{tm}, a SQL database™ and/or a Oracle database™. For example, if the transmitting device is asset tracking device 42 that is attached to a pallet of oranges (e.g., pallet 44), the device identifier 50 for asset tracking device 42 may define “pallet of oranges”. Alternatively, if the transmitting device is a fleet management device 56 attached to a dump truck (e.g., fleet vehicle 58), the device identifier 50 for fleet management device 56 may define “International 15 cubic yard dump truck/VIN# 123GX8723”. Further, if the transmitting device is a vehicle assistant device 60 within a vehicle, the device identifier 50 for vehicle assistant device 60 may define “2004 Acura RL; VIN# 609LV56314” (i.e., the vehicle in which vehicle assistant device 60 is installed) or “Robert Johnson, 123 Main Street, Spokane, Wash” (i.e., the owner of the vehicle in which vehicle assistant device 60 is installed).

Personal monitoring system 114 may include a location process 120 for processing e.g., personal data signal 112 to extract location signal 48 included within personal data signal 112 to determine the location of the transmitting device. As discussed above, examples of location signal 48 may include: a street address, latitudinal / longitudinal coordinates, or the individual GPS satellite signals. Accordingly, depending on the type of location signal 48 received, the manner in which location signal 48 is processed may vary. For example, if the location signal received is a street address, location process 120 may merely extract location signal 48 from personal data signal 112. Alternatively, if location signal 48 is latitudinal/longitudinal coordinates, upon extracting location signal 48 from personal data signal 112, location process 120 may correlate the received latitudinal/longitudinal coordinates with a street address/position on a map. Further, if location signal 48 is the individual GPS satellite signals, the individual GPS signals may be processed by location process 120 to generate latitudinal/longitudinal coordinates, which may then be correlated to a street address/position on a map.

Personal monitoring system 114 may include an identification process 122 for processing inbound data signals (e.g., personal data signals 108) to extract device identifier 50 and identify the device that transmitted the data signal. As discussed above, examples of device identifier 50 may include a cellular telephone number assigned to the transmitting device, an IP address, a MAC address and/or a device serial number. Further and as discussed above, monitoring system 10 may maintain a database 120 that correlates each assigned device identifier with a description for the transmitting device associated with the device identifier. For example, if the transmitting device is personal monitoring device 68, the device identifier 50 for personal monitoring device 68 may define “Sue Smith, 79 Old Hill Road, Centerville, Md.” (i.e., the owner of personal monitoring device 68).

Dispatchers 124, 126 may be available to field voice-based data signals (e.g., voice data signal 64). As discussed above, vehicle assistant device 60 and personal monitoring device 68 may be configured to allow for voice-based communication (via voice data signal 64) with monitoring system 10. For example, when a user of vehicle assistant device 60 depresses e.g., button 66 incorporated into vehicle assistant device 60, the user of vehicle assistant device 60 may be connected to dispatcher 124. Further, when user 70 depresses e.g., a button (not shown) incorporated into personal monitoring system 68, user 70 may be connected to dispatcher 126. As discussed above, depending on the type of voice-based communication (e.g., emergency or concierge, for example), dispatchers 124, 126 may handle the call directly (for e.g., concierge calls) or may forward the call to a third party (e.g., a 911 emergency dispatcher 128 external to monitoring system 10) or a user 130 whom the users of vehicle assistant device 60/personal monitoring device 68 is trying to reach.

In addition to forwarding information to user 130, user 130 may request information from dispatcher 124, 126. For example, user 130 may request location information concerning one or more of transmitting devices 14, 16, 18. Accordingly, assume that user 130 is the mother of user 70 (i.e., the wearer of personal monitoring device 68). Therefore, user 130 may contact e.g., dispatcher 126 and request location information concerning her daughter (i.e., user 70). If personal monitoring device 68 was configured to periodically provide location signal 48 to system 10, dispatcher 124 may provide user 130 with location information extracted from the last location signal 48 received from personal monitoring device 68. Alternatively, if personal monitoring device 68 is configured to only provide location information in response to a request from system 10, dispatcher 126 may query (e.g., ping) personal monitoring device 68, resulting in the transmission of data signal 12 (which includes location signal 48).

In addition to location information, user 130 may request (via a dispatcher) additional information from a transmitting device (if such information is available). For example and as discussed above, fleet management device 56 may include additional circuitry (e.g., interface system 52 and/or data sensors 54) that allows fleet management device 56 to include additional information within data signal 12. Therefore, fleet management device 56 may include e.g., ambient temperature sensors, humidity sensors, altitude sensors, acceleration sensors, vibration sensors and barometric pressure sensors. Accordingly, user 130 may request (via a dispatcher) such information from the transmitting device. As discussed above, similar additional information may be available from asset tracking device 42, vehicle assistant device 60, and personal monitoring device 68. Typically, prior to being able to receive the above-described information, user 130 may be required to authenticate their identity (e.g., through the use of a username/password, for example).

Monitoring system 10 may be configured to allow a user to access (via computer 132) monitoring system 10 and ascertain the above-described information (e.g., location, temperature, altitude, acceleration, vibration, and barometric pressure information). Typically, prior to being able to access system 10 and retrieve the above-described information, the user of computer 132 may be required to authenticate their identity (e.g., through the use of a username/password, or private key/public key encryption pair, for example).

A number of implementations have been described. Nevertheless, it will be understood that various modifications may be made. Accordingly, other implementations are within the scope of the following claims.

What is claimed is:

1. A method comprising:
receiving a data signal from a transmitting device;
processing the data signal to determine if the data signal is a device data signal or a personal data signal;
if the data signal is a device data signal, routing the device data signal to a device monitoring system; and
if the data signal is a personal data signal, routing the personal data signal to a personal monitoring system.

2. The method of claim 1 wherein:
the data signal is a device data signal; and
the transmitting device is chosen from the group consisting of a fleet management device, a vehicle assistant device, and an asset tracking device.

3. The method of claim 1 wherein the data signal is a personal data signal, and the transmitting device is a personal monitoring device.

4. The method of claim 1 wherein:
the transmitting device includes a GPS receiver for receiving a GPS signal from at least one of a plurality of GPS satellites;
the transmitting device is configured to process the GPS signal to generate a location signal indicative of a location of the transmitting device; and
the location signal is included in the data signal.

5. The method of claim 4 further comprising:
processing the location signal included within the data signal to determine the location of the transmitting device.

6. The method of claim 1 wherein the transmitting device includes a cellular transmitter for transmitting the data signal to a cellular network.

7. The method of claim 1 wherein the data signal includes a device identifier for identifying the transmitting device, the method further comprising:
processing the data signal to extract the device identifier; and
associating a device identity with the extracted device identifier.

8. The method of claim 1 wherein the data signal includes a voice-based signal component, the method further comprising:
routing the data signal to a dispatcher.

9. A computer program product residing on a computer readable medium having a plurality of instructions stored thereon which, when executed by a processor, cause the processor to perform operations comprising:
receiving a data signal from a transmitting device;
processing the data signal to determine if the data signal is a device data signal or a personal data signal;
if the data signal is a device data signal, routing the device data signal to a device monitoring system; and
if the data signal is a personal data signal, routing the personal data signal to a personal monitoring system.

10. The computer program product of claim 9 wherein:
the data signal is a device data signal; and
the transmitting device is chosen from the group consisting of a fleet management device, a vehicle assistant device, and an asset tracking device.

11. The computer program product of claim 9 wherein the data signal is a personal data signal, and the transmitting device is a personal monitoring device.

12. The computer program product of claim 9 wherein:
the transmitting device includes a GPS receiver for receiving a GPS signal from at least one of a plurality of GPS satellites;
the transmitting device is configured to process the GPS signal to generate a location signal indicative of a location of the transmitting device; and
the location signal is included in the data signal.

13. The computer program product of claim 12 further comprising instructions for:
processing the location signal included within the data signal to determine the location of the transmitting device.

14. The computer program product of claim 9 wherein the transmitting device includes a cellular transmitter for transmitting the data signal to a cellular network.

15. The computer program product of claim 9 wherein the data signal includes a device identifier for identifying the transmitting device, the computer program product further comprising instructions for:
processing the data signal to extract the device identifier; and
associating a device identity with the extracted device identifier.

16. The computer program product of claim 9 wherein the data signal includes a voice-based signal component, the computer program product further comprising instructions for:
routing the data signal to a dispatcher.

17. A system configured for:
receiving a data signal from a transmitting device;
processing the data signal to determine if the data signal is a device data signal or a personal data signal;
if the data signal is a device data signal, routing the device data signal to a device monitoring system; and
if the data signal is a personal data signal, routing the personal data signal to a personal monitoring system.

18. The system of claim 17 wherein:
the data signal is a device data signal; and
the transmitting device is chosen from the group consisting of a fleet management device, a vehicle assistant device, and an asset tracking device.

19. The system of claim 17 wherein the data signal is a personal data signal, and the transmitting device is a personal monitoring device.

20. The system of claim 17 wherein:
the transmitting device includes a GPS receiver for receiving a GPS signal from at least one of a plurality of GPS satellites;
the transmitting device is configured to process the GPS signal to generate a location signal indicative of a location of the transmitting device; and
the location signal is included in the data signal.

21. The system of claim 20 further comprising:
processing the location signal included within the data signal to determine the location of the transmitting device.

22. The system of claim 17 wherein the transmitting device includes a cellular transmitter for transmitting the data signal to a cellular network.

23. The system of claim 17 wherein the data signal includes a device identifier for identifying the transmitting device, the system further configured for:
processing the data signal to extract the device identifier; and
associating a device identity with the extracted device identifier.

24. The system of claim 17 wherein the data signal includes a voice-based signal component, the system further configured for:
routing the data signal to a dispatcher.
